(19) United States
(12) Patent Application Publication
(10) Pub. No.: US 2026/0167563 A1
(43) Pub. Date: Jun. 18, 2026

(54) METHOD TO ENHANCE POZZOLAN REACTIVITY UTILIZING ACID

(71) Applicant: Halliburton Energy Services, Inc., Houston, TX (US)

(72) Inventors: Thomas Jason Pisklak, Houston, TX (US); Claudia Carmen Osegueda, Houston, TX (US); Samuel Lewis, Houston, TX (US)

(73) Assignee: Halliburton Energy Services, Inc., Houston, TX (US)

(21) Appl. No.: 18/984,086

(22) Filed: Dec. 17, 2024

(51) Int. Cl. C04B 7/12; C04B 28/04; C09K 8/46

(52) U.S. Cl. CPC C04B 7/12; C04B 28/04; C09K 8/46

(57) ABSTRACT

A method of preparing an acid modified pozzolan may include: contacting a starting pozzolan with an acid to form a mixture of the starting pozzolan and the acid; reacting the mixture of starting pozzolan and the acid during an induction period to form reaction products; and recovering the acid modified pozzolan.

### BACKGROUND

In well cementing, such as well construction and remedial cementing, cement slurries are commonly utilized. Cement slurries may be used in a variety of subterranean applications. For example, in subterranean well construction, a pipe string (e.g., casing, liners, expandable tubulars, etc.) may be run into a well bore and cemented in place. The process of cementing the pipe string in place is commonly referred to as “primary cementing.” In a typical primary cementing method, a cement slurry may be pumped into an annulus between the walls of the well bore and the exterior surface of the pipe string disposed therein. The cement slurry may set in the annular space, thereby forming an annular sheath of hardened, substantially impermeable cement (i.e., a cement sheath) that may support and position the pipe string in the well bore and may bond the exterior surface of the pipe string to the subterranean formation. Among other things, the cement sheath surrounding the pipe string functions to prevent the migration of fluids in the annulus, as well as protecting the pipe string from corrosion. Cement slurries also may be used in remedial cementing methods, for example, to seal cracks or holes in pipe strings or cement sheaths, to seal highly permeable formation zones or fractures, to place a cement plug, and the like.

A particular challenge in wellbore and construction cementing may be to ensure that cements have consistent and predictable properties. Pozzolans are used in cement slurry designs for multiple purposes such as yield enhancement, carbon dioxide (CO₂) footprint reduction, and increased mechanical properties, for example. However, pozzolans can vary greatly in their reactivity with some being highly reactive and others having very low reactivity, and some may be inert in typical oilwell conditions. The variation in pozzolan reactivity may lead to geographic variation in cement designs depending on what pozzolans are available. Locations with highly reactive pozzolan sources can design slurries which have a much higher proportion of pozzolan, while those with low reactivity pozzolans may be limited to low concentrations since these pozzolans do not contribute as much to strength development or other properties of cement. Cement slurries prepared with pozzolans with relatively lower reactivity may not have the desired properties for oil well cementing.

Locations with relatively highly reactivity pozzolan sources may be able to formulate acceptable cement slurries with relatively lower cement content, such as Portland cement of less than 30 wt. %, including Portland-free cement slurries. Those locations with relatively lower reactivity pozzolans are generally limited to slurries with much higher Portland cement such as Portland content of >50 wt. % or even >70 wt. %. Furthermore, as the supplementary cementitious material (SCM) content, including pozzolans, of the cement slurry is increased, the temperature at which the cement slurry can effectively cure to form barriers with acceptable physical properties is also increased. When the SCM content reaches ˜50 wt. % or greater with relatively lower reactivity pozzolans, the lower temperature limit for these slurries to effectively cure is around 140° F. (60° C.).

Reactivity of pozzolans, also known as pozzolanic activity, measures the extent to which a pozzolanic material can chemically interact with calcium hydroxide (lime) in water, creating compounds with cementitious properties. This reactivity is determined indirectly by creating a test mix where the pozzolan either replaces part of the cement or is added to the cement mixture or slurry. Following the preparation, the mix's compressive strength is tested after a designated curing period, adhering to standards such as those outlined in American Petroleum Institute (API) Recommended Practice (RP) 10B-2 Second Edition, Apr. 1, 2013), which provides guidelines for testing oil well cements. The observed increase in compressive strength over time serves as an indirect measure of the pozzolanic activity, indicating the formation of additional cementitious compounds from the pozzolanic reactions. A pozzolan exhibiting relatively higher reactivity leads to an improvement in compressive strength when compared to one with relatively lower reactivity when included in the same fraction in the test mix.

The reactivity of pozzolans can be increased by several means. For example, a pozzolan can be interground with another relatively more reactive material to increase the overall activity of the blend, the pozzolan can be ground to a smaller particle size to increase surface area and reactivity, or the pozzolan can be calcined in a furnace to increase the reactivity. However, each of the aforementioned techniques to increase reactivity can be energy and/or material intensive and may result in a pozzolan with only marginally higher reactivity than the starting material. Furthermore, the aforementioned techniques to increase reactivity may not provide a pozzolan that, when included in a cement slurry in an amount greater than 50 wt. %, allows the cement slurry to set to form a barrier with acceptable physical properties at temperatures below 140° F. (60° C.) when measured according to API RP 10B-2.

### BRIEF DESCRIPTION OF THE DRAWINGS

These drawings illustrate certain aspects of some of the embodiments of the present disclosure and should not be used to limit or define the disclosure.

FIG. 1 is a block flow diagram of a method to produce an acid modified pozzolan, in accordance with some embodiments of the present disclosure.

FIG. 2 is a schematic illustration of an example system for the preparation and delivery of a cement slurry to a wellbore, in accordance with some embodiments of the present disclosure.

FIG. 3 is a schematic illustration of example surface equipment that may be used in the placement of a cement slurry in a wellbore, in accordance with some embodiments of the present disclosure.

FIG. 4 is a schematic illustration of the example placement of a cement slurry into a wellbore annulus, in accordance with some embodiments of the present disclosure.

FIG. 5 is graph of an ultrasonic cement analyzer test of cement slurries, in accordance with some embodiments of the present disclosure.

### DETAILED DESCRIPTION

The present disclosure may generally relate to acid modified pozzolans (also referred to as increasing pozzolanic activity). More particularly, embodiments may be directed to methods of preparing acid modified pozzolans and methods of preparing cement slurries with acid modified pozzolans.

As used herein, “acid modified pozzolan” refers to a pozzolan product produced by a method which includes contacting a starting pozzolanic material with an acid and other optional reagents and allowing the starting pozzolanic material to further react with the acid during the course of an induction period to form the acid modified pozzolan. The acid includes a material that reacts with the starting pozzolanic material to produce reaction products which include cementitious compounds and/or compounds which can participate in cementitious reactions. Different reaction products may be present on a surface of the acid modified pozzolan during the induction period. Some reaction products may be formed and later consumed as the reactions between the acid, starting pozzolanic material, and/or reaction products proceeds.

The acid modified pozzolan has an observed increase in compressive strength over time as compared to the starting pozzolanic material when included in a cement slurry and tested adhering to standards such as those outlined in American Petroleum Institute (API) Recommended Practice (RP) 10B-2 Second Edition, Apr. 1, 2013), which provides guidelines for testing oil well cements. The reaction with the acid may also enhance other properties of the starting pozzolan, such as improved rheologies in cement slurries prepared with the acid modified pozzolan. In some embodiments, the catalyst is consumed during the reaction with the starting pozzolanic material.

In some embodiments, the starting pozzolan is contacted with the acid such that the induction period takes place during a point in the supply chain of mining, processing, transportation, and/or delivery of the pozzolan such that the acid modified pozzolan is produced as part of the supply chain.

Pozzolans are typically mined from natural deposits such as volcanic ash, natural glasses, and tuffs. Suitable pozzolan deposits may be identified through geological surveying, for example, to identify pozzolans which meet physical criteria for inclusion in a cement such as silica content and reactivity. The pozzolan deposits may be mined in open bit mining where heavy machinery excavators, bulldozers, and front-end loaders may be used to remove an overburden material covering the pozzolan and then to extract the pozzolan material. In some cases, the pozzolan material may be extracted using blasting to break the pozzolan material into smaller pieces and/or utilizing a drilling rig or direct digging to mine the pozzolan material. In some embodiments, the pozzolan material may be mined in underground mines utilizing techniques such as room and pillar mining and/or drilling vertical and horizonal tunneling to reach pozzolan deposits.

After mining the pozzolan material, pozzolan material is typically loaded into heavy machinery such as dump trucks, large haul trucks, and/or front-end loaders directly at the mine face or pit. These vehicles may transport the material from the excavation site to a nearby processing plant or stockpile area. In some embodiments, a primary crusher is utilized before moving the pozzolan material from the mining site. In some embodiments, a fixed or mobile belt is utilized to transport crushed or coarsely broken materials from the mining site to the processing plant or stockpile area.

In some embodiments, the mined pozzolan material is contacted with the acid before mining and/or shortly after mining the pozzolan material. In further embodiments, the mined pozzolan material is contacted with the acid before being loaded into heavy machinery and transported to the processing plant or stockpile area. In some embodiments, the acid is contacted with the pozzolan material before or after a primary crusher. In alternative embodiments, the acid is contacted with the pozzolan material in the primary crusher. In embodiments, the acid is contacted with the pozzolan material after a primary crusher while the pozzolan material is transported on a fixed or mobile belt. In further embodiments, the pozzolan material is contacted with the acid while in storage at a stockpile area and/or contacted before entering the processing plant. Thus, the induction period may begin, for example, shortly after the pozzolan material is mined and/or transported.

After mining, the pozzolan material undergoes a series of processing steps, such as in a processing plant, to produce a pozzolan product with physical properties which are suitable for the intended use of the pozzolan product, such as inclusion in a cement slurry for a cementing application. In embodiments, a the mined pozzolan material is crushed to reduce an average particle size of the pozzolan material. The crushing step can be performed with jaw crushers, cone crushers, or impact crushers, for example, depending on the pozzolan material's properties. Several crushing stages may be implemented to reduce the average particle size of the pozzolan material for processability. In some embodiments, the mined pozzolan material is transported by a conveyance from a stockpile area to the crushing step and/or transported from the crushing step using a conveyance. Typical conveyance means used in pozzolan processing include conveyor belts, elevators or bucket conveyors, and pneumatic conveyance. In embodiments, the pozzolan material is contacted with the acid before or after the crushing step, such as for example, while being transported by a conveyance into or in between crushing stages. In further embodiments, the acid is contacted with the pozzolan material within one or more crushing stages.

In further embodiments, after crushing, the pozzolan material may be ground such as in a ball mill or vertical roller mill, to produce a finer pozzolan material. The pozzolan material is typically ground to a size where the pozzolan material has sufficient reactivity for its intended use as the reaction rate depends in part on the fineness of the pozzolan material. In embodiments, the pozzolan material is ground through several grinding steps to produce a pozzolan material with the desired fineness. In some embodiments, the pozzolan material from the crushing step transported by a conveyance from the crushing step to the grinding step using a conveyance. In embodiments, the pozzolan material is contacted with the acid before or after the grinding step, such as for example, while being transported by a conveyance into or in between grinding stages. In further embodiments, the acid is contacted with the pozzolan material within one or more grinding stages.

In further embodiments, after grinding, the pozzolan material may introduced into a screen or classifier to separate the particles of the pozzolan material into different sizes thereby providing a pozzolan material with a narrower particle size distribution comprising a desired fraction of the pozzolan material. In some embodiments, the pozzolan material from the grinding step transported by a conveyance from the grinding step to the screening step using a conveyance. In embodiments, the pozzolan material is contacted with the acid before or after the screening step, such as for example, while being transported by a conveyance into or in between screening stages. In further embodiments, the acid is contacted with the pozzolan material within one or more screening stages.

After undergoing processing by one or more of the steps described above, the pozzolan material may be transported from the processing plant to storage or shipping. For example, the pozzolan material may be transported from the processing plant utilizing a conveyance such as belts, elevators or bucket conveyors, and/or pneumatic conveyance. In embodiments, the pozzolan material is contacted with the acid before or during the transportation of the pozzolan material from the processing plant. In embodiments, the pozzolan material is stored in suitable containers including tanks and silos before being further transported. In embodiments, the pozzolan material is loaded onto a railcar including hopper cars and/or covered gondolas for shipping. In further embodiments the pozzolan material is loaded into bulk carriers, barges, or container ships which may include conveying the pozzolan material into the ship's holds. In some embodiments, the pozzolan material is loaded into containerized trucks for shipping. In smaller scale or retail distribution, the pozzolan material may be bagged or stored in silos. In embodiments, the pozzolan material is contacted with the acid before or after the transportation from the processing plant, such as for example, while being transported by a conveyance. In further embodiments, the acid is contacted with the pozzolan material within as the pozzolan material is prepared for shipping, such as before or during loading the pozzolan material into a railcar, marine vessel, truck, or storage silo, or example.

Thus, the pozzolans may be contacted with the acid at any point in the pozzolan supply chain such that the induction period during which the reaction between the acid and the pozzolan occurs, may begin at any point in the pozzolan supply chain. The reactions between the reaction between the acid produce reaction products which may be present on a surface of the acid modified pozzolan. Some reaction products may be formed and later consumed as the reactions between the acid, starting pozzolanic material, and/or reaction products proceeds. Thus, the composition of the acid modified pozzolan may change throughout the induction period until the induction period ends. In embodiments, the induction period may occur entirely within a processing plant such as when the starting pozzolan material is contacted with the acid during one or more of the processing steps and/or in between processing steps. In some embodiments, the induction period may occur entirely during storage or transportation of the acid modified pozzolan such as when the starting pozzolan material is contacted with the acid before or during one or more of the transportation, storage, or shipping steps. In further embodiments, the induction period occurs during the one or more of processing, storing, and/or shipping the pozzolan material.

In embodiments, the induction period can occur during shipping of the acid modified pozzolan. For example, if a starting pozzolan is contacted with an acid prior to or during loading the pozzolan material into a railcar, water faring vessel, or truck, advantageously the induction period may take place during the shipping of the material thereby providing the acid modified pozzolan when the material is delivered.

Thus, the disclosed method to produce the acid modified pozzolan may be integrated into the existing pozzolan supply chain in a manner which does not disrupt the supply chain. After contacting the pozzolan with the acid, the treated pozzolan remains as a free-flowing material thereby allowing the treated pozzolan to be conveyed throughout the pozzolan supply chain by conventional means. The methods to produce the acid modified pozzolans have many advantages, including that the contacting step can be performed on-the-fly as the pozzolan is conveyed through the supply chain without disrupting the flow of pozzolan, and the reaction induction period can occur in transport storage eliminating a separate material storage step. Thus, the method to produce the acid modified pozzolan can be integrated into the pozzolan supply chain without changing the material handling of the pozzolan material, while providing a pozzolan with enhanced benefits when included in cement compositions as compared to the starting pozzolan.

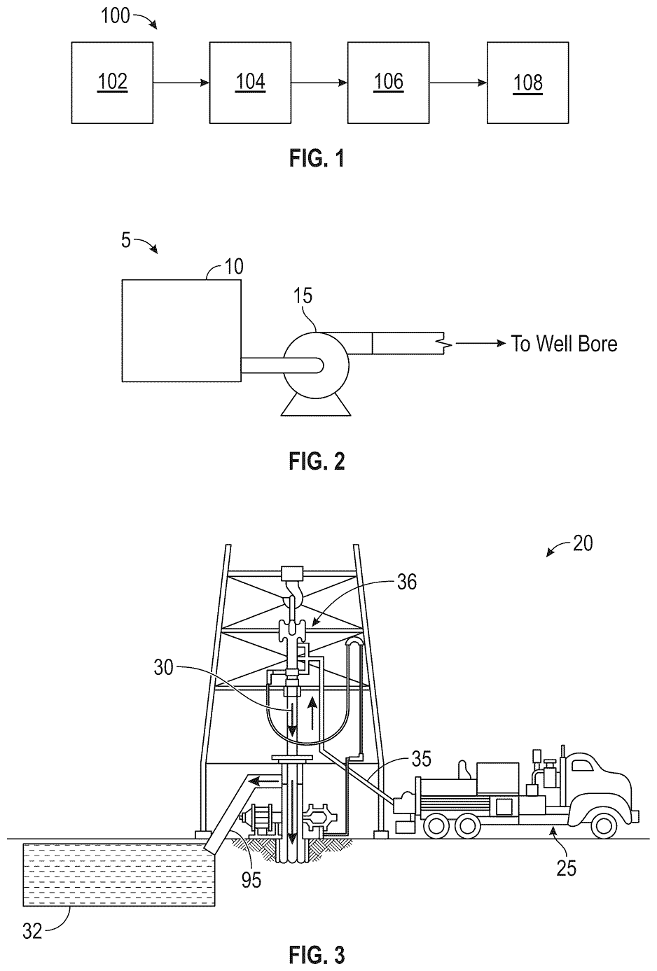

FIG. 1 is a block flow diagram of a method 100 for preparing an acid modified pozzolan. As shown in FIG. 1, method 100 begins at block 102 where a starting pozzolanic material is contacted with an acid to form a treated pozzolanic material. In embodiments, the starting pozzolanic material is contacted with the acid by spraying the acid onto the starting pozzolanic material. In embodiments, the acid is contacted with the starting pozzolanic material while the starting pozzolanic material is being conveyed at a point in the pozzolan supply chain, such as during pneumatically conveying the pozzolan. In embodiments, the acid is sprayed onto the starting pozzolanic material while the pozzolanic material is pneumatically conveyed. In some embodiments, the acid is contacted with the starting pozzolanic material by spin coating, fluidized bed coating, packed bed coating, dip coating, and/or where starting pozzolan is added to an acid solution to form a slurry and dried using a rotary drum.

From block 102, method 100 proceeds to block 104 where the treated pozzolanic material is conveyed to a storage container, which provides short-term storage and/or long-term storage. In embodiments the pozzolanic material is conveyed to a storage container such as a silo, a railcar, a barge, and/or a truck for transportation. The silo may be a fully enclosed container or a container open to the environment. Blocks 102 and blocks 104 can also be combined in embodiments, such that the contacting between starting pozzolan and acid occurs in the storage container itself, such as near the vicinity of an oil and gas well.

From block 104, method 100 proceeds to block 106 where the treated pozzolanic material is stored for an induction period, such as in the storage container in block 104, where the acid further reacts with the starting pozzolan to produce the acid modified pozzolan. From block 106, method 100 proceeds to block 108 where the acid modified pozzolan is delivered to an end user ready for inclusion in a cement composition. In embodiments, the enhanced reactivity is recovered after the induction period and collected and or stored for later use and delivery. In further embodiments, the recovered enhanced reactivity is prepared for delivery to a customer such as by bagging, binning, containerizing, or otherwise storing the recovered acid modified pozzolan.

The acid modified pozzolan has several advantages including that the acid modified pozzolan has greater reactivity at lower temperatures as compared to the starting pozzolan used to produce the acid modified pozzolan. The acid modified pozzolan can also have upgraded higher reactivity at larger particle sizes. The reaction of the acid with the starting pozzolan also increases the sphericity and roundness of the pozzolan particles providing better rheological properties when included in a cement slurry as compared to starting pozzolan particles and provides a more flowable powder. Some methods of contacting the acid and the starting pozzolanic material produce agglomerates of acid modified pozzolan, where the size of the agglomerates can be adjusted by an agitation step. Additionally, when the acid modified pozzolan is included in a settable spacer fluid, the spacer fluid can set at a lower temperature and have an increased strength.

As discussed above, the reactivity of pozzolans is determined indirectly by creating a test mix where the pozzolan either replaces part of the cement or is added to the cement mixture or slurry and testing the mix's compressive strength according to API RP 10B-2. A pozzolan exhibiting upgraded higher reactivity leads to an improvement in compressive strength when compared to one with relatively lower reactivity when included in the same fraction in the test mix. Similarly, an acid modified pozzolan has a higher reactivity as compared to the starting pozzolan utilized to make the acid modified pozzolan.

Pozzolans are typically classified as materials containing siliceous and/or aluminous constituents, which react with water and calcium hydroxide (or calcium ions and/or hydroxide ions from other sources) to form a set composition. Any suitable starting pozzolan may be utilized in the present application to produce acid modified pozzolan, including for example, fly ash, volcanic ash, tuft, pumicites, fumed silica, precipitated silica, high surface area silica, silica fume, slag, lime ash, perlite, glass such as silicate glass, soda-lime glass, soda-silica glass, borosilicate glass, aluminosilicate glass, volcanic rock, calcined clays, clays such as metakaolin, partially calcined clays, mine tailings, recycled glass, bottom ash, cenospheres, bioashes, agricultural waste ash, silica flour, crystalline silica, cement kiln dust, glass bubbles, diatomaceous earth, zeolite, shale, vitrified shale, and ground vitrified pipe, for example.

While the present list of suitable starting pozzolans is non-exhaustive, it is believed that any pozzolan suitable for use in an oilwell cement and/or spacer fluids is also suitable for the processes described herein to produce acid modified pozzolan.

The acid may impart several properties to the starting pozzolanic material (such as by modifying the surface structure and/or surface composition) to form the acid modified pozzolan, including without limitation, surface etching, formation of nucleation sites, formation of microcrystalline calcium silica hydrate on the surface, dissolution of silicates to form more reactive silicate species, and others. Without being limited by theory, the starting pozzolanic material may undergo geopolymeric reactions with the acid to form geopolymeric products on a surface of the starting pozzolanic material.

The acid modified pozzolan has upgraded reactivity from the starting pozzolanic material. The upgraded reactivity is observed indirectly by creating a test mix where the pozzolan either replaces part of the cement or is added to the cement mixture or slurry. Following the preparation, the mix's compressive strength is tested after a designated curing period, adhering to standards such as those outlined in American Petroleum Institute (API) Recommended Practice (RP) 10B-2 Second Edition, Apr. 1, 2013), which provides guidelines for testing oil well cements. The observed increase in compressive strength over time serves as an indirect measure of the pozzolanic activity, indicating the formation of additional cementitious compounds from the pozzolanic reactions. A pozzolan exhibiting upgraded reactivity leads to an improvement in compressive strength when compared to the starting pozzolanic when included in the same fraction in the test mix.

In embodiments, the acid includes any acid which can modify the starting pozzolan to produce a relatively more reactive acid modified pozzolan. In embodiments, acids suitable for use in the presently disclosed process include mineral acids and organic acids, hydracids such as hydrogen fluoride (HF), hydrochloric acid (HCl), hydrogen bromide (HBr), hydrogen iodide (HI), and hydrogen azide (HN₃), nitric acid (HNO₃), sulfuric acid (H₂SO₄), phosphoric acid (H₃PO₄), boric acid (H₃BO₃), and perchloric acid (HClO₄), lactic acid, acetic acid, formic acid, citric acid, oxalic acid, uric acid, tartaric acid, itaconic acid, and acrylic acid for example.

In embodiments, the starting pozzolan may be contacted with an amount of acid such that the starting pozzolan remains in a pneumatically transferable powder form, and at a sufficient concentration to impart enhanced reactivity and greater cementitious properties (e.g. compressive strength) to the acid modified pozzolan as compared to the starting pozzolan. Advantageously, utilizing a relatively high concentration acid solution reduces the overall volume of solution required to impart a desired increased reactivity to the starting pozzolan, and reduces the agglomeration of the starting pozzolan particles such that the treated pozzolan particles remain in a pneumatically transferrable particulate form. Generally, the amount of water provided by the acid contacted with the starting pozzolan should be sufficiently below the water requirement of the starting pozzolan such that the starting pozzolan does not form a slurry.

In embodiments, where the acid includes an aqueous solution of an acid such as in a solvent including water, the concentration of acid in solution may be in a range that is between approximately 0.5 molar (moles per liter) at the lower bound of the range, to the solubility limit (saturation) of acid at the upper range. Other concentrations may be used in other embodiments.

In embodiments, the starting pozzolan is contacted with the acid solution in an amount of 0.01 grams of acid solution per gram of starting pozzolan to 5.0 grams of acid solution per gram of starting pozzolan. Alternatively, the starting pozzolan is contacted with the acid solution in an amount of 0.01 grams to 0.1 grams of acid solution per gram of starting pozzolan, 0.1 grams to 0.3 grams of acid solution per gram of starting pozzolan, 0.3 grams to 0.5 grams of acid solution per gram of starting pozzolan, 0.5 grams to 1.0 grams of acid solution per gram of starting pozzolan, 1.0 grams to 2.0 grams of acid solution per gram of starting pozzolan, 2.0 grams to 3.0 grams of acid solution per gram of starting pozzolan, 3.0 grams to 5.0 grams of acid solution per gram of starting pozzolan, or any ranges therebetween.

In embodiments, the acid solution can further include at least one material selected from the group consisting of ethylene glycol, propylene glycol, Portland cement, calcium aluminate cement, triethanolamine, nano calcium-silicate-hydrate, sodium aluminate, sodium metasilicate, sodium phosphate, potassium phosphate, sodium hydrogen phosphate, potassium hydrogen phosphate, sodium dihydrogen phosphate, potassium dihydrogen phosphate, sodium borate, magnesium oxide, lithium nitrate, calcium nitrate, potassium nitrate, calcium bromide, calcium chloride, calcium formate, sodium bromide, sodium chloride, sodium formate, sodium nitrate, potassium chloride, potassium bromide, potassium formate, and combinations thereof.

In embodiments where the acid solution is formed from acid dissolved in a solvent, the starting pozzolanic material and the acid solution may be contacted by spraying the acid solution onto the starting pozzolanic material while agitating the starting pozzolanic material. The agitation may be provided by any suitable means such as a ribbon blender, fluidized mixer, a cone mixer, a V blender, or any other mixer capable of agitating and mixing the starting pozzolanic material. In some embodiments the agitation is provided during pneumatic transfer of the pozzolanic material.

The starting pozzolanic material and acid may be mixed for any suitable amount of time to disperse the acid onto the surface of the particles of starting pozzolanic material. For example, the starting pozzolanic material and acid may be mixed for a period of time in a range of about 1 second to about 24 hours. Alternatively, the starting pozzolanic material and acid may be mixed for 1 second to 1 minute, 1 minute to 10 minutes, 1 minutes to 1 hour, 1 hour to about 2 hours, about 2 hours to about 5 hours, or about 5 hours to about 24 hours, or any ranges therebetween for example. The mixing process may be carried out at any temperature, for example ambient temperature. The mixing process may also be carried out at temperatures ranging from about 5° C. to about 80° C. Alternatively, from about 5° C. to about 20° C., about 20° C. to about 60° C., about 60° C. to about 80° C., or any ranges therebetween.

After mixing, the starting pozzolanic material is stored for an induction period to allow the acid dispersed on the starting pozzolanic material to further react with the surface of the acid to produce the acid modified pozzolan. During the induction period, the pozzolanic material may be stirred either continuously or intermittently or may be kept in a quiescent state. The starting pozzolanic material can be stored for any suitable induction period such as a period of time in a range of from 1 day to 1 year. Alternatively, the starting pozzolanic material is stored for an induction period of from 1 day to 3 days, 3 days to 1 week, 1 week to 2 weeks, 2 weeks to 3 months, 3 months to 1 year, or any ranges therebetween. The induction period may be carried out at any suitable temperature, for example ambient temperature, or temperatures ranging from about 5° C. to about 80° C. Alternatively, from about 5° C. to about 20° C., about 20° C. to about 60° C., about 60° C. to about 80° C., or any ranges therebetween. During the induction period, the starting pozzolanic material is further reacted to form the acid modified pozzolan. Optionally the pozzolanic material is dried using heat or air, for example, during and or after the induction period.

In embodiments, the pozzolanic material is continuously or intermittently agitated during the induction period. The agitation may be provided by any suitable means such as a ribbon blender, fluidized mixer, a cone mixer, a V blender, a conveyor belt, an Eirich mixer, or any other mixer capable of agitating and mixing the starting pozzolanic material. In some embodiments the agitation is provided during pneumatic transfer of the pozzolanic material.

Optionally, after the induction period the acid modified pozzolan may be further processed. As discussed above, some contacting methods may form agglomerates of acid modified pozzolan. In embodiments, the average particle size of the acid modified pozzolan is reduced, such as by milling, after the induction step to provide an acid modified pozzolan with a smaller particle size. In embodiments, the acid modified pozzolan is milled after the induction step to provide a powder with a d50 particle size distribution in which the average or mean size of the particle is 1 micron, 200 microns, or anywhere therebetween. In further embodiments, the acid modified pozzolan may have a d50 particle size distribution with an average or mean size from about 1 micron to about 200 microns, from about 5 microns to about 100 microns, or from about 10 microns to about 25 microns.

### Properties of Acid Modified Pozzolan

In embodiments, the acid modified pozzolan has more favorable rheological properties than the starting pozzolan which is utilized to prepare the acid modified pozzolan. In an example embodiment, a 13.9 pound per gallon (ppg) (1688 kg/m³) cement slurry prepared with 20% BWOB (by weight of dry blend) class H Portland cement, 80% BWOB acid modified pozzolan, and 55% BWOB water, can have an apparent viscosity as measured according to American Petroleum Institute (API) Recommended Practice (RP) 10B-2 Second Edition, Apr. 1, 2013, at 3 rpm at a point in a range of 800 cP to 1200 cP, at 6 rpm at a point in a range of 500 cP to 700 cP, at 30 rpm at a point in a range of 180 cP to 240 cP, at 60 rpm at a point in a range of 120 cP to 160 cP, at 100 rpm at a point in a range of 80 cP to 120 cP, at 200 rpm at a point in a range of 50 cP to 100 cP, and at 300 rpm at a point in a range of 25 cp to 80 cP. The API Recommended Practice 10B-2 is hereby incorporated by reference herein in its entirety.

In embodiments, the acid modified pozzolan has more favorable low temperature properties than the starting pozzolan which is utilized to prepare the acid modified pozzolan. In an example embodiment, a 13.9 pound per gallon (ppg) (1688 kg/m³) cement slurry prepared with 20% BWOB class H Portland cement, 80% BWOB acid modified pozzolan, and 55% BWOB water, can have a 24 hour compressive strength as measured in an ultrasonic cement analyzer according to API RP 10B-2 at 80° F. (26.6° C.) and 3000 psi (20.68 MPa) at a point in a range of 65 psi (448 kPa) to 150 psi (1034 kPa) or greater, a 72 hour compressive strength at a point in a range of 150 psi (1034 kPa) to 250 psi (1723 kPa) or greater, and a 7 day compressive strength at a point in a range of 600 psi (4136 kPa) to 800 psi (5515 kPa) or greater. In embodiments, when included in a neat class H Portland cement slurry in an amount of 80% BWOB or less and mixed with water to a density of about 11 ppg (1318 kg/m³) to about 19 ppg (2276 kg/m³), the acid modified pozzolan has the property of forming a set composition at less than 140° F.

### Cement Slurries

Cement slurries described herein may generally include a water and an acid modified pozzolan. In embodiments, the cement slurry further includes a hydroxide source such as calcium hydroxide (CaOH₂) and/or a hydraulic cement. In embodiments, the cement slurry is substantially free of hydraulic cement and comprises water, a hydroxide source, and an acid modified pozzolan. Without limitation, the acid modified pozzolan may be included in the cement slurries in an amount in the range of from about 0.5% to about 100% by weight of dry blend (BWOB) in the cement slurry. For example, the acid modified pozzolan may be present in an amount ranging between any of and/or including any of 0.5%, 1%, 5%, 10%, 15%, 20%, 25%, 30%, 35%, 40%, 45%, 50%, 55%, 60%, 65%, 70%, 75%, 80%, 90%, 95%, or 100% BWOB used to prepare a cement slurry.

A variety of hydraulic cements may be utilized in accordance with the present disclosure, including, but not limited to, those comprising calcium, aluminum, silicon, oxygen, iron, and/or sulfur, which set and harden by reaction with water. Suitable hydraulic cements may include, but are not limited to, Portland cements, pozzolana cements, gypsum cements, alumina cements, silica cements, and any combination thereof. In certain examples, the hydraulic cement may include a Portland cement. In some examples, the Portland cements may include Portland cements that are classified as Classes A, C, H, and G cements according to API Specification 10A Twenty-Fifth Edition, March 2019 the entirety of which is incorporated by reference herein. In addition, hydraulic cements may include cements classified by American Society for Testing and Materials (ASTM) in C150-07 (Standard Specification for portland Cement) incorporated by reference herein, C595-08a (Standard Specification for Blended Hydraulic Cement) incorporated by reference herein or C1157-08a (Performance Specification for Hydraulic Cements) incorporated by reference herein such as those cements classified as ASTM Type I, II, III, IL, CL, or any other hydraulic cement suitable for a particular application. In embodiments the hydraulic cement includes Ordinary Portland Cement such as grade33, grade 43, and/or grade 53. The hydraulic cement may be included in the cement slurry in any amount suitable for a particular composition. Without limitation, the hydraulic cement may be included in the cement slurries in an amount in the range of from about 10% to about 80% by weight of dry blend in the cement slurry. For example, the hydraulic cement may be present in an amount ranging between any of and/or including any of about 10%, about 15%, about 20%, about 25%, about 30%, about 35%, about 40%, about 45%, about 50%, about 55%, about 60%, about 65%, about 70%, about 75%, or about 80% BWOB used to prepare a cement slurry.

The water utilized in the cement slurries and/or the acid solution may be from any source provided that it does not contain an excess of compounds that may undesirably affect other components in the cement slurries and/or acid solution. For example, a cement slurry may include fresh water and/or saltwater. Saltwater generally may include one or more dissolved salts therein and may be saturated or unsaturated as desired for a particular application. Seawater or brines may be suitable for use in some examples. Further, the water may be present in an amount sufficient to form a pumpable slurry. In certain examples, the water may be present in the cement slurry in an amount in the range of from about 33% to about 200% by weight of the cementitious materials. For example, the water in the cement may be present in an amount ranging between any of and/or including any of about 33%, about 50%, about 75%, about 100%, about 125%, about 150%, about 175%, or about 200% by weight of the cementitious materials. The cementitious materials referenced may include all components which contribute to the compressive strength of the cement slurry such as the hydraulic cement and supplementary cementitious materials, for example.

As mentioned above, the cement slurry may include supplementary cementitious materials. The supplementary cementitious material may be any material that contributes to the desired properties of the cement slurry. Some supplementary cementitious materials may include, without limitation, fly ash, blast furnace slag, silica fume, pozzolans, kiln dust, and clays, for example.

The cement slurry may include kiln dust as a supplementary cementitious material. “Kiln dust,” as that term is used herein, refers to a solid material generated as a by-product of the heating of certain materials in kilns. The term “kiln dust” as used herein is intended to include kiln dust made as described herein and equivalent forms of kiln dust. Depending on its source, kiln dust may exhibit cementitious properties in that it can set and harden in the presence of water. Examples of suitable kiln dusts include cement kiln dust, lime kiln dust, and combinations thereof. Cement kiln dust may be generated as a by-product of cement production that is removed from the gas stream and collected, for example, in a dust collector. Usually, large quantities of cement kiln dust are collected in the production of cement that are commonly disposed of as waste. The chemical analysis of the cement kiln dust from various cement manufactures varies depending on a number of factors, including the particular kiln feed, the efficiencies of the cement production operation, and the associated dust collection systems. Cement kiln dust generally may include a variety of oxides, such as SiO₂, Al₂O₃, Fe₂O₃, CaO, MgO, SO₃, Na₂O, and K₂O. The chemical analysis of lime kiln dust from various lime manufacturers varies depending on several factors, including the particular limestone or dolomitic limestone feed, the type of kiln, the mode of operation of the kiln, the efficiencies of the lime production operation, and the associated dust collection systems. Lime kiln dust generally may include varying amounts of free lime and free magnesium, limestone, and/or dolomitic limestone and a variety of oxides, such as SiO₂, Al₂O₃, Fe₂O₃, CaO, MgO, SO₃, Na₂O, and K₂O, and other components, such as chlorides. Cement kiln dust (CKD) may include a partially calcined kiln feed which is removed from the gas stream and collected in a dust collector during the manufacture of cement. The chemical analysis of CKD from various cement manufactures varies depending on a number of factors, including the particular kiln feed, the efficiencies of the cement production operation, and the associated dust collection systems. CKD generally may comprise a variety of oxides, such as SiO₂, Al₂O₃, Fe₂O₃, CaO, MgO, SO₃, Na₂O, and K₂O. The CKD and/or lime kiln dust may be included in examples of the cement slurry in an amount suitable for a particular application.

In some examples, the cement slurry may further include one or more of slag, natural glass, shale, amorphous silica, or metakaolin as a supplementary cementitious material. Slag is generally a granulated, blast furnace by-product from the production of cast iron including the oxidized impurities found in iron ore. The cement may further include shale. A variety of shales may be suitable, including those including silicon, aluminum, calcium, and/or magnesium. Examples of suitable shales include vitrified shale and/or calcined shale. In some examples, the cement slurry may further include amorphous silica as a supplementary cementitious material. Amorphous silica is a powder that may be included in embodiments to increase cement compressive strength. Amorphous silica is generally a byproduct of a ferrosilicon production process, wherein the amorphous silica may be formed by oxidation and condensation of gaseous silicon suboxide, SiO, which is formed as an intermediate during the process

In some examples, the cement slurry may further include a variety of fly ashes as a supplementary cementitious material which may include fly ash classified as Class C, Class F, or Class N fly ash according to API Specification 10. In some examples, the cement slurry may further include zeolites as supplementary cementitious materials. Zeolites are generally porous alumino-silicate minerals that may be either natural or synthetic. Synthetic zeolites are based on the same type of structural cell as natural zeolites and may comprise aluminosilicate hydrates. As used herein, the term “zeolite” refers to all natural and synthetic forms of zeolite.

Where used, one or more of the aforementioned supplementary cementitious materials may be present in the cement slurry. For example, without limitation, one or more supplementary cementitious materials may be present in an amount of about 0.1% to about 80% by BWOB used to prepare a cement slurry. For example, the supplementary cementitious materials may be present in an amount ranging between any of and/or including any of about 0.1%, about 10%, about 20%, about 30%, about 40%, about 50%, about 60%, about 70%, or about 80% BWOB used to prepare a cement slurry.

In some examples, the cement slurry may further include hydrated lime. As used herein, the term “hydrated lime” will be understood to mean calcium hydroxide. In some embodiments, the hydrated lime may be provided as quicklime (calcium oxide) which hydrates when mixed with water to form the hydrated lime. The hydrated lime may be included in examples of the cement slurry, for example, to form a hydraulic composition with the supplementary cementitious components. For example, the hydrated lime may be included in a supplementary cementitious material-to-hydrated-lime weight ratio of about 10:1 to about 1:1 or 3:1 to about 5:1. Where present, the hydrated lime may be included in the set cement slurry in an amount in the range of from about 10% to about 100% by weight of the cement slurry, for example. In some examples, the hydrated lime may be present in an amount ranging between any of and/or including any of about 10%, about 20%, about 40%, about 60%, about 80%, or about 100% by weight of the cement slurry. In some examples, the cementitious components present in the cement slurry may consist essentially of one or more supplementary cementitious materials and the hydrated lime. For example, the cementitious components may primarily comprise the supplementary cementitious materials and the hydrated lime without any additional components (e.g., Portland cement, fly ash, slag cement) that hydraulically set in the presence of water.

Lime may be present in the cement slurry in several; forms, including as calcium oxide and or calcium hydroxide or as a reaction product such as when Portland cement reacts with water. Alternatively, lime may be included in the cement slurry by an amount of silica in the cement slurry. A cement slurry may be designed to have a target lime to silica weight ratio. The target lime to silica ratio may be a molar ratio, molal ratio, weight ratio, or any other equivalent way of expressing a relative amount of silica to lime. Any suitable target lime to silica weight ratio may be selected including from about 10/90 lime to silica (on a weight to weight basis) to about 40/60 lime to silica by weight. Alternatively, about 10/90 lime to silica by weight to about 20/80 lime to silica by weight, about 20/80 lime to silica by weight to about 30/70 lime to silica by weight, or about 30/70 lime to silica by weight to about 40/60 lime to silica by weight.

Other additives suitable for use in subterranean cementing operations also may be included in embodiments of the cement slurry. Examples of such additives include, but are not limited to: weighting agents, lightweight additives, gas-generating additives, mechanical-property-enhancing additives, lost-circulation materials, filtration-control additives, fluid-loss-control additives, defoaming agents, foaming agents, thixotropic additives, and combinations thereof. In embodiments, one or more of these additives may be added to the cement slurry after storing but prior to the placement of a cement slurry into a subterranean formation. In some examples, the cement slurry may further include a dispersant. Examples of suitable dispersants include, without limitation, sulfonated-formaldehyde-based dispersants (e.g., sulfonated acetone formaldehyde condensate) or polycarboxylated ether dispersants. In some examples, the dispersant may be included in the cement slurry in an amount in the range of from about 0.01% to about 5% by weight of the cementitious materials. In specific examples, the dispersant may be present in an amount ranging between any of and/or including any of about 0.01%, about 0.1%, about 0.5%, about 1%, about 2%, about 3%, about 4%, or about 5% BWOB used to prepare a cement slurry.

In some examples, the cement slurry may further include a set retarder. A broad variety of set retarders may be suitable for use in the cement slurries. For example, the set retarder may comprise phosphonic acids, such as ethylenediamine tetra(methylene phosphonic acid), diethylenetriamine penta(methylene phosphonic acid), etc.; lignosulfonates, such as sodium lignosulfonate, calcium lignosulfonate, etc.; salts such as stannous sulfate, lead acetate, monobasic calcium phosphate, organic acids, such as citric acid, tartaric acid, etc.; cellulose derivatives such as hydroxyl ethyl cellulose (HEC) and carboxymethyl hydroxyethyl cellulose (CMHEC); synthetic co- or ter-polymers comprising sulfonate and carboxylic acid groups such as sulfonate-functionalized acrylamide-acrylic acid co-polymers; borate compounds such as alkali borates, sodium metaborate, sodium tetraborate, potassium pentaborate; derivatives thereof, or mixtures thereof. Examples of suitable set retarders include, among others, phosphonic acid derivatives. Generally, the set retarder may be present in the cement slurry in an amount sufficient to delay the setting for a desired time. In some examples, the set retarder may be present in the cement slurry in an amount in the range of from about 0.01% to about 10% by weight of the cementitious materials. In specific examples, the set retarder may be present in an amount ranging between any of and/or including any of about 0.01%, about 0.1%, about 1%, about 2%, about 4%, about 6%, about 8%, or about 10% BWOB used to prepare a cement slurry.

In some examples, the cement slurry may further include an accelerator. A broad variety of accelerators may be suitable for use in the cement slurries. For example, the accelerator may include, but are not limited to, aluminum sulfate, alums, calcium chloride, calcium nitrate, calcium nitrite, calcium formate, calcium sulphoaluminate, calcium sulfate, gypsum-hemihydrate, sodium aluminate, sodium carbonate, sodium chloride, sodium silicate, sodium sulfate, ferric chloride, or a combination thereof. In some examples, the accelerators may be present in the cement slurry in an amount in the range of from about 0.01% to about 10% by weight of the cementitious materials. In specific examples, the accelerators may be present in an amount ranging between any of and/or including any of about 0.01%, about 0.1%, about 1%, about 2%, about 4%, about 6%, about 8%, or about 10% by BWOB used to prepare a cement slurry.

Cement slurries generally should have a density suitable for a particular application. By way of example, the cement slurry may have a density in the range of from about 8 pounds per gallon (“ppg”) (959 kg/m³) to about 20 ppg (2397 kg/m³), or about 8 ppg to about 12 ppg (1437. kg/m³), or about 12 ppg to about 16 ppg (1917.22 kg/m³), or about 16 ppg to about 20 ppg, or any ranges therebetween. Examples of the cement slurry may be foamed or unfoamed or may comprise other means to reduce their densities, such as hollow microspheres, low-density elastic beads, or other density-reducing additives known in the art.

In embodiments, the acid modified pozzolan is included in a spacer fluid. Embodiments of the spacer fluids of the present disclosure comprise water and the acid modified pozzolan. In further embodiments, the spacer fluid further includes a suspension agent, may be used to aid in suspending the acid modified pozzolan in the spacer fluid. Examples of suitable suspending aids may include viscosifiers, such as those described above which include swellable clays such as bentonite or biopolymers such as cellulose derivatives (e.g., hydroxyethyl cellulose, carboxymethyl cellulose, carboxymethyl hydroxyethyl cellulose). The spacer fluids generally should have a density suitable for a particular application. In some embodiments, the spacer fluids may have a density in the range of from about 4 pounds per gallon (“ppg”) to about 24 ppg. In other embodiments, the spacer fluids may have a density in the range of about 4 ppg to about 17 ppg. In yet other embodiments, the spacer fluids may have a density in the range of about 8 ppg to about 13 ppg. Embodiments of the spacer fluids may be foamed or unfoamed or comprise other means to reduce their densities such as lightweight additives.

Cement slurries described herein may generally include a water and an enhanced reactivity pozzolan. After mixing the cement slurry, the particles of enhanced reactivity pozzolan and other cementitious components such as hydraulic cement, undergo hydraulic or pozzolanic reactions to form a set composition. The cement slurries described herein are suitable for construction cementing as well as wellbore cementing. Some non-limiting uses of cement slurries which include an enhanced reactivity pozzolan include, but are not limited to, pre-tensioned forms, rail road construction, tunnel construction, pylon constructions, dam construction, building construction, bridge construction, blast wall construction, aqueduct construction, sewer pipe construction, parking lots and garages, bollards and barriers, foundations, wind turbine pads, landfill barriers, retention pond construction, ballast, crane weights, and nuclear waste containment, and decorative applications including pavestones and decorative walls and barriers, for example. The cement slurries described herein are also useful in wellbore construction cementing such as cementing liners, hangers, and tubulars, as well as kick plugs, set plugs, and plug and abandon applications.

FIG. 2 illustrates an example system 5 for preparation of a cement slurry including and delivery of the cement slurry to a wellbore. The cement slurry may be any cement slurry disclosed herein including those comprising an acid modified pozzolan disclosed herein. As shown, the cement slurry may be mixed in mixing equipment 10, such as a jet mixer, re-circulating mixer, or a batch mixer, for example, and then pumped via pumping equipment 15 to the wellbore. In some examples, the mixing equipment 10 and the pumping equipment 15 may be disposed on one or more cement trucks. In some examples, a jet mixer may be used, for example, to continuously mix a dry blend including the cement slurry, for example, with the water as it is being pumped to the wellbore.

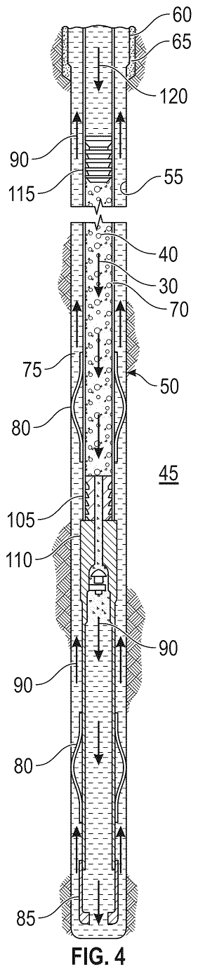

An example technique for placing a cement slurry into a subterranean formation will now be described with reference to FIGS. 3 and 4. FIG. 3 illustrates example surface equipment 20 that may be used in placement of a cement slurry. The cement slurry may be any cement slurry disclosed herein. A cement slurry recipe be developed, for example, using the cement fluid loss models described herein, and a cement slurry may be prepared based on the cement slurry recipe. It should be noted that while FIG. 3 generally depicts a land-based operation, those skilled in the art will readily recognize that the principles described herein are equally applicable to subsea operations that employ floating or sea-based platforms and rigs, without departing from the scope of the disclosure. As illustrated by FIG. 3, the surface equipment 20 may include a cementing unit 25, which may include one or more cement trucks. The cementing unit 25 may include mixing equipment 10 and pumping equipment 15 (e.g., FIG. 2). The cementing unit 25 may pump a cement slurry 30 through a feed pipe 35 and to a cementing head 36 which conveys the cement slurry 30 downhole.

Turning now to FIG. 4, the cement slurry 30, may be placed into a subterranean formation 45. As illustrated, a wellbore 50 may be drilled into one or more subterranean formations 45. While the wellbore 50 is shown extending generally vertically into the one or more subterranean formation 45, the principles described herein are also applicable to wellbores that extend at an angle through the one or more subterranean formations 45, such as horizontal and slanted wellbores. As illustrated, the wellbore 50 includes walls 55. In the illustrated example, a surface casing 60 has been inserted into the wellbore 50. The surface casing 60 may be cemented to the walls 55 of the wellbore 50 by cement sheath 65. In the illustrated example, one or more additional conduits (e.g., intermediate casing, production casing, liners, etc.), shown here as casing 70 may also be disposed in the wellbore 50. As illustrated, there is a wellbore annulus 75 formed between the casing 70 and the walls 55 of the wellbore 50 and/or the surface casing 60. One or more centralizers 80 may be attached to the casing 70, for example, to centralize the casing 70 in the wellbore 50 prior to and during the cementing operation.

With continued reference to FIG. 4, the cement slurry 30 may be pumped down the interior of the casing 70. The cement slurry 30 may be allowed to flow down the interior of the casing 70 through the casing shoe 85 at the bottom of the casing 70 and up around the casing 70 into the wellbore annulus 75. The cement slurry 30 may be allowed to set in the wellbore annulus 75, for example, to form a cement sheath that supports and positions the casing 70 in the wellbore 50. While not illustrated, other techniques may also be utilized for introduction of the cement slurry 30. By way of example, reverse circulation techniques may be used that include introducing the cement slurry 30 into the subterranean formation 45 by way of the wellbore annulus 75 instead of through the casing 70.

As it is introduced, the cement slurry 30 may displace other fluids 90, such as drilling fluids and/or spacer fluids that may be present in the interior of the casing 70 and/or the wellbore annulus 75. At least a portion of the displaced fluids 90 may exit the wellbore annulus 75 via a flow line 95 and be deposited, for example, in one or more retention pits 32 (e.g., a mud pit), as shown on FIG. 3. Referring again to FIG. 4, a bottom plug 105 may be introduced into the wellbore 50 ahead of the cement slurry 30, for example, to separate the cement slurry 30 from the other fluids 90 that may be inside the casing 70 prior to cementing. After the bottom plug 105 reaches the landing collar 110, a diaphragm or other suitable device should rupture to allow the cement slurry 30 through the bottom plug 105. In FIG. 4, the bottom plug 105 is shown on the landing collar 110. In the illustrated example, a top plug 115 may be introduced into the wellbore 50 behind the cement slurry 30. The top plug 115 may separate the cement slurry 30 from a displacement fluid 120 and push the cement slurry 30 through the bottom plug 105.

The cement slurries disclosed herein may be used in a variety of subterranean applications, including primary and remedial cementing. The cement slurries may be introduced into a subterranean formation and allowed to set. In primary cementing applications, for example, the cement slurries may be introduced into the annular space between a conduit located in a wellbore and the walls of the wellbore (and/or a larger conduit in the wellbore), wherein the wellbore penetrates the subterranean formation. The cement slurry may be allowed to set in the annular space to form an annular sheath of hardened cement. The cement slurry may form a barrier that prevents the migration of fluids in the wellbore. The cement slurry may also, for example, support the conduit in the wellbore. In remedial cementing applications, the cement slurry may be used, for example, in squeeze cementing operations or in the placement of cement plugs. By way of example, the cement slurry may be placed in a wellbore to plug an opening (e.g., a void or crack) in the formation, in a gravel pack, in the conduit, in the cement sheath, and/or between the cement sheath and the conduit (e.g., a micro annulus).

The following statements may describe certain embodiments of the disclosure but should be read to be limiting to any particular embodiment.

Statement 1. A method of preparing an acid modified pozzolan comprising: contacting a starting pozzolan with an acid to form a mixture of the starting pozzolan and the acid; reacting the mixture of starting pozzolan and the acid during an induction period to form reaction products; and recovering the acid modified pozzolan.

Statement 2. The method of statement 1 wherein the starting pozzolan comprises at least one pozzolan selected from the group consisting of fly ash, volcanic ash, tuft, pumicites, fumed silica, precipitated silica, high surface area silica, silica fume, slag, lime ash, perlite, silicate glass, soda-lime glass, soda-silica glass, borosilicate glass, aluminosilicate glass, volcanic rock, calcined clays, metakaolin, partially calcined clays, mine tailings, recycled glass, bottom ash, cenospheres, bioashes, agricultural waste ash, silica flour, crystalline silica, cement kiln dust, glass bubbles, diatomaceous earth, zeolite, shale, vitrified shale, ground vitrified pipe, and combinations thereof.

Statement 3. The method of any of statements 1-2 wherein the acid comprises at least one acid selected from the group consisting of hydrogen fluoride (HF), hydrochloric acid (HCl), hydrogen bromide (HBr), hydrogen iodide (HI), hydrogen azide (HN₃), nitric acid (HNO₃), sulfuric acid (H₂SO₄), phosphoric acid (H₃PO₄), boric acid (H₃BO₃), perchloric acid (HClO₄), lactic acid, acetic acid, formic acid, citric acid, oxalic acid, uric acid, tartaric acid and combinations thereof.

Statement 4. The method of any of statements 1-3 wherein the acid is dissolved in an aqueous solvent to from an acid solution.

Statement 5. The method of any of statements 1-4 wherein the acid is dissolved in the aqueous solvent in an amount of at least about 0.5 moles per liter to saturation.

Statement 6. The method of any of statements 1-5 wherein the starting pozzolan is contacted with the acid solution in an amount of about 0.01 grams of acid solution to about 5.0 grams of acid solution per gram of starting pozzolan.

Statement 7. The method of any of statements 1-6 wherein the acid solution is sprayed onto the starting pozzolan.

Statement 8. The method of any of statements 1-7 wherein the acid solution is mixed using a mixer while contacting the starting pozzolan with the acid solution.

Statement 9. The method of any of statements 1-8 wherein the mixer comprises at least one mixer selected from the group consisting of a ribbon blender, a fluidized mixer, a cone mixer, a V blender, conveyor belt, Eirich mixer and combinations thereof.

Statement 10. A method comprising: preparing a slurry comprising an acid modified pozzolan and water; and allowing the slurry to set to form a hardened composition.

Statement 11. The method of statement 10, further comprising introducing the slurry into a subterranean formation and allowing the slurry to set to form the hardened composition in the subterranean formation.

Statement 12. The method of any of statements 10-11 wherein the slurry further comprises a hydraulic cement selected from the group consisting of Portland cement, pozzolana cement, gypsum cement, alumina cement, silica cement, and any combination thereof.

Statement 13. The method of any of statements 10-12 wherein the acid modified pozzolan is produced by a process comprising: contacting a starting pozzolan with an acid to form a mixture of the starting pozzolan and an acid modified pozzolan; reacting the mixture of starting pozzolan and the acid during an induction period to form reaction products; and recovering the acid modified pozzolan.

Statement 14. The method of any of statements 10-13 wherein the starting pozzolan comprises at least one pozzolan selected from the group consisting of fly ash, volcanic ash, tuft, pumicites, fumed silica, precipitated silica, high surface area silica, silica fume, slag, lime ash, perlite, silicate glass, soda-lime glass, soda-silica glass, borosilicate glass, aluminosilicate glass, volcanic rock, calcined clays, metakaolin, partially calcined clays, mine tailings, recycled glass, bottom ash, cenospheres, bioashes, agricultural waste ash, silica flour, crystalline silica, cement kiln dust, glass bubbles, diatomaceous earth, zeolite, shale, vitrified shale, and ground vitrified pipe.

Statement 15. The method of any of statements 10-14 wherein the acid comprises at least one acid selected from the group consisting of hydrogen fluoride (HF), hydrochloric acid (HCl), hydrogen bromide (HBr), hydrogen iodide (HI), hydrogen azide (HN₃), nitric acid (HNO₃), sulfuric acid (H₂SO₄), phosphoric acid (H₃PO₄), boric acid (H₃BO₃), perchloric acid (HClO₄), lactic acid, acetic acid, formic acid, citric acid, oxalic acid, uric acid, tartaric acid and combinations thereof.

Statement 16. An acid modified pozzolan produced by a process comprising: contacting a starting pozzolan with an acid to form a mixture of the starting pozzolan and the acid; reacting the mixture of starting pozzolan and the acid during an induction period to form reaction products; and recovering the acid modified pozzolan.

Statement 17. The acid modified pozzolan produced by the process of statement 16 wherein the starting pozzolan comprises at least one pozzolan selected from the group consisting of fly ash, volcanic ash, tuft, pumicites, fumed silica, precipitated silica, high surface area silica, silica fume, slag, lime ash, perlite, silicate glass, soda-lime glass, soda-silica glass, borosilicate glass, aluminosilicate glass, volcanic rock, calcined clays, metakaolin, partially calcined clays, mine tailings, recycled glass, bottom ash, cenospheres, bioashes, agricultural waste ash, silica flour, crystalline silica, cement kiln dust, glass bubbles, diatomaceous earth, zeolite, shale, vitrified shale, ground vitrified pipe, and combinations thereof.

Statement 18. The acid modified pozzolan produced by the process of any of statements 16-17 wherein the acid comprises at least one acid selected from the group consisting of hydrogen fluoride (HF), hydrochloric acid (HCl), hydrogen bromide (HBr), hydrogen iodide (HI), hydrogen azide (HN₃), nitric acid (HNO₃), sulfuric acid (H₂SO₄), phosphoric acid (H₃PO₄), boric acid (H₃BO₃), perchloric acid (HClO₄), lactic acid, acetic acid, formic acid, citric acid, oxalic acid, uric acid, tartaric acid and combinations thereof.

Statement 19. The acid modified pozzolan produced by the process of any of statements 16-18 wherein the acid comprises an acid solution and the starting pozzolan is contacted with the acid solution in an amount of about 0.01 grams of acid solution to about 5.0 grams of acid solution per gram of starting pozzolan.

Statement 20. The acid modified pozzolan produced by the process of any of statements 16-19 wherein the acid comprises an acid solution and wherein the acid solution and starting pozzolan are mixed using a mixer while contacting the starting pozzolan with the acid solution.

### EXAMPLES

To facilitate a better understanding of the present disclosure, the following examples of certain aspects of some embodiments are given. In no way should the following examples be read to limit, or define, the entire scope of the disclosure.

### Example 1

In this example an acid modified pozzolan was prepared. First, 250.0 grams of perlite powder was weighed and transferred to an 8-inch diameter pan. In a separate container, 4.15 grams 12N hydrochloric acid (HCl) was dissolved in 24.85 grams water to form a 2N HCl solution. The HCl solution was sprayed onto the perlite powder while agitating the perlite powder to achieve dispersion of the acid solution on the perlite powder. After all the HCl solution had been sprayed on the powder, the perlite powder was agitated for a period of time. It was observed that the perlite powder had absorbed the acid solution and that the powder was still in a free-flowing state. The powder was then transferred to a 500 ml bottle and sealed. The treated powder was stored in quiescent storage for a period of three days and intermittently agitated during the storage period. It was observed that the agitation in storage led to the formation of approximately spherical particles of perlite which were friable and easily breakable during the slurry mixing process below.

### Example 2

In this example, the treated perlite from example 1 was utilized in low Portland cement slurries. The compositions are shown in Table 1-3. The first cement slurry in Table 1 is a conventional low Portland cement blend with 20% by weight of blend (BWOB) Portland cement and 80% BWOB non-treated perlite. The second cement slurry in Table 2 is a low Portland cement blend with 20% by BWOB Portland cement and 80% BWOB treated perlite from example 1. The third cement slurry in Table 3 is a low Portland cement blend with 20% BWOB Portland cement and 80% BWOB non-treated perlite and 2N HCl dissolved in the mix water.

TABLE 1

Perlite Blend

| Material | % BWOB | Wt. (g) |
|---|---|---|
| Portland Cement, Class H | 20 | 64 |
| Standard Perlite | 80 | 256 |
| Water | 55 | 176 |
| Slurry Density (ppg) | 13.9 | |

TABLE 2

Acid Treated
Perlite Blend

| Material | % BWOB | Wt. (g) |
|---|---|---|
| Portland Cement, Class H | 20 | 64 |
| Treated Perlite | 80 | 256 |
| Water | 55 | 176 |
| Slurry Density (ppg) | 12.9 | |

TABLE 3

Acid Perlite Blend

| Material | % BWOB | Wt. (g) |
|---|---|---|
| Portland Cement, Class H | 20 | 64 |
| Regular Perlite | 80 | 256 |
| Water | 55 | 176 |
| 2N HCl Solution | 25 | 25 |
| Slurry Density (ppg) | 12.8 | |

The slurries were prepared following standard cement practices. First, all dry components were weighed into a glass container having a clean lid and agitated by hand until blended. Tap water was then weighed into a blender jar. The dry components were then mixed into the water and the slurries were blended. For the third slurry in Table 3, the 2N HCl solution was first dissolved into the mix water, which was allowed to cool to room temperature prior to blending in the dry components.

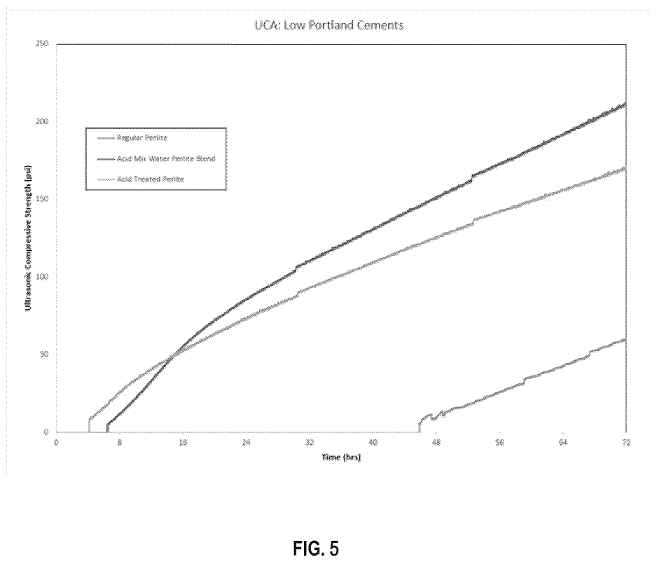

Immediately after blending the rheologies of each of the slurries were then taken at room temperature using a Fann RheoVADR® rheometer with bob and sleeve attachment. The compressive strengths (C.S.) were measured with an ultrasonic cement analyzer (UCA) set at 80° F. and 3000 psi. The results of the UCA analysis are shown in FIG. 5. The UCA results are summarized in Table 4.

TABLE 4

| | Time at 50 | 24 hr. UCA | 72 hr. UCA | 7 Day UCA |
|---|---|---|---|---|
| Slurry | psi (hh:mm) | C.S. (psi) | C.S. (psi) | C.S. (psi) |
| Perlite Blend | 67:21 | 0 | 60 | 278 |
| Acid Treated Perlite Blend | 15:04 | 73 | 170 | 308 |
| Acid Perlite Blend | 15:00 | 86 | 211 | 355 |

The apparent viscosity (AVIS) was measured at 80° F. and 3000 psi. The results of the AVIS measurements are shown in Table 5.

TABLE 5

| | AVIS Values at Specified RPM | | | | | | |
|---|---|---|---|---|---|---|---|
| | 3 | 6 | 30 | 60 | 100 | 200 | 300 |
| | rpm | rpm | rpm | rpm | rpm | rpm | rpm |
| Slurry | (cP) | (cP) | (cP) | (cP) | (cP) | (cP) | (cP) |
| Perlite Blend | 5158 | 3550 | 1491 | 1026 | 779 | 536 | 431 |
| Acid Treated | 1054 | 619 | 211 | 141 | 107 | 75 | 62 |
| Perlite Blend | | | | | | | |
| Acid Perlite | 1219 | 763 | 297 | 207 | 161 | 116 | 97 |
| Blend | | | | | | | |

It was observed that the low Portland cement blend of Table 1 does not develop compressive strength at low temperatures and/or high supplementary cementitious material (SCM) content. This is evidenced by the compressive strength development of the non-treated perlite slurry (Table 1) as shown in FIG. 5 and Table 5. After 72 hours at 80° F. the compressive strength was only 60 psi and at 7 days it was 278 psi. Additionally, the slurry was highly viscous as shown in Table 9, and a 6 RPM AVIS of 3850 cP which indicates that it would not be mixable under typical operational conditions. The elevated AVIS values for 30 to 300 RPM indicate that this slurry would be challenging, if not impossible to pump under normal oilwell conditions.

In contrast, the treated perlite slurry in Table 2 showed a much greater rate of compressive strength development, reaching 171 psi at 72 hours under the same conditions. The Treated Perlite cement developed 2.85 times more compressive strength at 72 hours than the non-treated perlite. Furthermore, the rheology of the Treated Perlite cement slurry is much more desirable. At 6 RPM the AVIS is 619 cP which is more than 5.7 times as low as the non-treated perlite. This trend lower AVIS trend continues throughout the rest of the measurements with all the AVIS values falling in the pumpable range.

The slurry in Table 3 contained the same amount of HCl used in the treatment, however, the 2N HCl was added directly into the mix water at blend time. It was observed that compressive strength development of the acid perlite blend as similar to the acid treated perlite blend. It was further observed that the acid treated perlite blend has lower AVIS measurements at all RPM.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular examples disclosed above are illustrative only, as the present disclosure may be modified and practiced in different but equivalent manners apparent to those skilled in the art having the benefit of the teachings herein. Although individual examples are discussed, the disclosure covers all combinations of all those examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method of preparing an acid modified pozzolan comprising:
contacting a starting pozzolan with an acid to form a mixture of the starting pozzolan and the acid;
reacting the mixture of starting pozzolan and the acid during an induction period to form reaction products; and
recovering the acid modified pozzolan.

2. The method of claim 1 wherein the starting pozzolan comprises at least one pozzolan selected from the group consisting of fly ash, volcanic ash, tuft, pumicites, fumed silica, precipitated silica, high surface area silica, silica fume, slag, lime ash, perlite, silicate glass, soda-lime glass, soda-silica glass, borosilicate glass, aluminosilicate glass, volcanic rock, calcined clays, metakaolin, partially calcined clays, mine tailings, recycled glass, bottom ash, cenospheres, bioashes, agricultural waste ash, silica flour, crystalline silica, cement kiln dust, glass bubbles, diatomaceous earth, zeolite, shale, vitrified shale, ground vitrified pipe, and combinations thereof.

3. The method of claim 1 wherein the acid comprises at least one acid selected from the group consisting of hydrogen fluoride (HF), hydrochloric acid (HCl), hydrogen bromide (HBr), hydrogen iodide (HI), hydrogen azide (HN₃), nitric acid (HNO₃), sulfuric acid (H₂SO₄), phosphoric acid (H₃PO₄), boric acid (H₃BO₃), perchloric acid (HClO₄), lactic acid, acetic acid, formic acid, citric acid, oxalic acid, uric acid, tartaric acid and combinations thereof.

4. The method of claim 1 wherein the acid is dissolved in an aqueous solvent to from an acid solution.

5. The method of claim 4 wherein the acid is dissolved in the aqueous solvent in an amount of at least about 0.5 moles per liter to saturation.

6. The method of claim 4 wherein the starting pozzolan is contacted with the acid solution in an amount of about 0.01 grams of acid solution to about 5.0 grams of acid solution per gram of starting pozzolan.

7. The method of claim 4 wherein the acid solution is sprayed onto the starting pozzolan.

8. The method of claim 7 wherein the acid solution is mixed using a mixer while contacting the starting pozzolan with the acid solution.

9. The method of claim 8 wherein the mixer comprises at least one mixer selected from the group consisting of a ribbon blender, a fluidized mixer, a cone mixer, a V blender, conveyor belt, Eirich mixer and combinations thereof.

10. A method comprising:
preparing a slurry comprising an acid modified pozzolan and water; and
allowing the slurry to set to form a hardened composition.

11. The method of claim 10, further comprising introducing the slurry into a subterranean formation and allowing the slurry to set to form the hardened composition in the subterranean formation.

12. The method of claim 11 wherein the slurry further comprises a hydraulic cement selected from the group consisting of Portland cement, pozzolana cement, gypsum cement, alumina cement, silica cement, and any combination thereof.

13. The method of claim 11 wherein the acid modified pozzolan is produced by a process comprising:
contacting a starting pozzolan with an acid to form a mixture of the starting pozzolan and an acid modified pozzolan;
reacting the mixture of starting pozzolan and the acid during an induction period to form reaction products; and
recovering the acid modified pozzolan.

14. The method of claim 13 wherein the starting pozzolan comprises at least one pozzolan selected from the group consisting of fly ash, volcanic ash, tuft, pumicites, fumed silica, precipitated silica, high surface area silica, silica fume, slag, lime ash, perlite, silicate glass, soda-lime glass, soda-silica glass, borosilicate glass, aluminosilicate glass, volcanic rock, calcined clays, metakaolin, partially calcined clays, mine tailings, recycled glass, bottom ash, cenospheres, bioashes, agricultural waste ash, silica flour, crystalline silica, cement kiln dust, glass bubbles, diatomaceous earth, zeolite, shale, vitrified shale, and ground vitrified pipe.

15. The method of claim 13 wherein the acid comprises at least one acid selected from the group consisting of hydrogen fluoride (HF), hydrochloric acid (HCl), hydrogen bromide (HBr), hydrogen iodide (HI), hydrogen azide (HN₃), nitric acid (HNO₃), sulfuric acid (H₂SO₄), phosphoric acid (H₃PO₄), boric acid (H₃BO₃), perchloric acid (HClO₄), lactic acid, acetic acid, formic acid, citric acid, oxalic acid, uric acid, tartaric acid and combinations thereof.

16. An acid modified pozzolan produced by a process comprising:
contacting a starting pozzolan with an acid to form a mixture of the starting pozzolan and the acid;
reacting the mixture of starting pozzolan and the acid during an induction period to form reaction products; and
recovering the acid modified pozzolan.

17. The acid modified pozzolan produced by the process of claim 16 wherein the starting pozzolan comprises at least one pozzolan selected from the group consisting of fly ash, volcanic ash, tuft, pumicites, fumed silica, precipitated silica, high surface area silica, silica fume, slag, lime ash, perlite, silicate glass, soda-lime glass, soda-silica glass, borosilicate glass, aluminosilicate glass, volcanic rock, calcined clays, metakaolin, partially calcined clays, mine tailings, recycled glass, bottom ash, cenospheres, bioashes, agricultural waste ash, silica flour, crystalline silica, cement kiln dust, glass bubbles, diatomaceous earth, zeolite, shale, vitrified shale, ground vitrified pipe, and combinations thereof.

18. The acid modified pozzolan produced by the process of claim 16 wherein the acid comprises at least one acid selected from the group consisting of hydrogen fluoride (HF), hydrochloric acid (HCl), hydrogen bromide (HBr), hydrogen iodide (HI), hydrogen azide (HN₃), nitric acid (HNO₃), sulfuric acid (H₂SO₄), phosphoric acid (H₃PO₄), boric acid (H₃BO₃), perchloric acid (HClO₄), lactic acid, acetic acid, formic acid, citric acid, oxalic acid, uric acid, tartaric acid and combinations thereof.

19. The acid modified pozzolan produced by the process of claim 16 wherein the acid comprises an acid solution and the starting pozzolan is contacted with the acid solution in an amount of about 0.01 grams of acid solution to about 5.0 grams of acid solution per gram of starting pozzolan.

20. The acid modified pozzolan produced by the process of claim 16 wherein the acid comprises an acid solution and wherein the acid solution and starting pozzolan are mixed using a mixer while contacting the starting pozzolan with the acid solution.
